(19) United States
(12) Patent Application Publication
(10) Pub. No.: US 2023/0330612 A1
(43) Pub. Date: Oct. 19, 2023

(54) FIXED-BED TUBULAR REACTOR

(71) Applicant: COMMISSARIAT À L'ÉNERGIE ATOMIQUE ET AUX ÉNERGIES ALTERNATIVES, Paris (FR)

(72) Inventors: Albin Chaise, Grenoble (FR); Alain Bengaouer, Grenoble (FR); Frédéric Ducros, Grenoble (FR)

(21) Appl. No.: 18/245,469

(22) PCT Filed: Sep. 22, 2021
(86) PCT No.: PCT/FR2021/051624

§ 371 Date: Mar. 15, 2023

(30) Foreign Application Priority Data
Sep. 29, 2020 (FR) 2009861

(51) Int. Cl. B01J 8/06; B01J 8/00; B01J 8/02

(52) U.S. Cl. CPC B01J 8/065; B01J 8/009; B01J 8/0214; B01J 2208/0092; B01J 2208/00938

(57) ABSTRACT

A tubular reactor comprises a powder bed in an annular space delimited by a first wall, of a hollow tube and a second wall, of a hollow insert, the hollow insert comprises a distribution chamber and a collection chamber, separated by at least one partition wall, the distribution chamber is provided with a plurality of distributing openings whereas the collection chamber is provided with a collecting opening, the plurality of distributing openings and the collecting opening are formed at the second wall, the distributing openings enabling the distribution of a gas capable of being admitted through the intake opening from the distribution chamber—towards the annular space, and the collecting opening enabling the collection of the gas distributed in the annular space by the collection chamber.

### DESCRIPTION OF INVENTION

### Technical Field

The present invention relates to the field of exchanger reactors. In particular, the present invention relates to the field of catalytic exchanger reactors implementing a solid catalyst, and in particular a solid catalyst in the form of powder.

In this respect, the present invention provides a catalytic exchanger reactor capable of implementing exothermic organic synthesis processes. In particular, these organic compounds may comprise synthetic fuels and a combustible.

### Prior Art

Catalytic reactors using solid catalysts are widely implemented for the synthesis of organic compounds such as synthetic fuels or combustibles, among which mention may be made of natural gas substitutes, dimethyl ether or methanol.

In particular, these compounds are obtained by reaction of hydrogen and carbon monoxide in the presence of a suitable solid catalyst.

Nonetheless, the chemical reactions relating to the synthesis of these compounds are very exothermic, and release an amount of heat likely to degrade the solid catalyst. In particular, this degradation of the solid catalyst is reflected by a deactivation of the latter, and leads to a reduction in the degree of conversion of the chemical species in presence. The selectivity of the involved reactions is also affected.

In practice, these reactions may be implemented in a shell-tube type reactor-exchanger which comprises a reactive channel provided with the solid catalyst and continuously cooled by a heat-transfer fluid. In this reactor type, the reactive gases circulate axially in the tubes which contain a catalyst, for example in the form of powder.

Nevertheless, despite the implementation of cooling by the heat-transfer fluid, this reactor type remains sensitive to the heat released by the reactions occurring in said reactor.

In particular, a hot spot, generally observed proximate to the reactive gas inlet, degrades the solid catalyst, and therefore reduces the performances of the reactor-exchanger.

In order to overcome these problems, an arrangement has then been proposed allowing splitting the distribution of the reagents over the entire length of the tubes. This solution then allows obtaining better temperature homogeneity over the entire length of the reactor.

In this respect, the documents U.S. Pat. Nos. 3,758,279, 4,374,094, EP0560157, IT8021172 and U.S. Pat. No. 2,997,374 propose reactor-exchangers implementing a distribution of the reagents from an annular distribution space. In particular, these reactor-exchangers, with a generally cylindrical shape, comprise, arranged coaxially and starting from the outside of the reactor, a tube, the annular distribution space, a catalyst charge and a collection space.

Nonetheless, this arrangement is not satisfactory.

Indeed, the presence of the annular distribution space disposed around the catalyst charge limits the heat transfers from the catalyst to the tube, making the generally considered cooling systems ineffective. Nevertheless, it remains possible to insert heat-conducting elements in the reactor. Nonetheless, such a solution remains incompatible with reactors comprising tubes with a small diameter.

Conversely, the document CN103990420 suggests implementing an insert provided with a distribution chamber and a collection chamber, disposed at the centre of a tube and defining with the latter an annular space accommodating the solid catalyst.

Nonetheless, the arrangement suggested in this document does not enable homogeneous distribution within the annular space. More particularly, this arrangement does not allow obtaining an optimum temperature profile within the solid catalyst.

FIG. 1 of the document U.S. Pat. No. 8,961,909 represents another example of a shell-tube type reactor. In particular, this reactor is provided with an injection tube, immersed in a catalytic powder bed, and along which holes are formed. In particular, these are arranged so as to ensure injection of the reactive gas at different levels of the catalytic powder bed, and thus limit the apparition of hot spots in said bed.

Nonetheless, this reactor is not satisfactory.

Indeed, in order to ensure cooling thereof, this reactor requires the set-up of a plurality of circulation circuits of a heat-transfer fluid, which increase its complexity accordingly.

The document U.S. Pat. No. 7,402,719, in particular in FIG. 3a, discloses another example of a reactor arranged so as to enable a staged injection of a reagent C for reaction thereof with a reagent A. In this respect, this reactor comprises two layers (or channels) separated by a wall and intended to ensure the circulation of the reagent A and of the reagent C, respectively. Moreover, the two layers are in fluid communication by means of a plurality of holes formed in the wall separating them. In particular, these holes are arranged in order to ensure a progressive mixing of the reagent C with the reagent A. Thus, this progressive mixing allows limiting the apparition of hot spots. However, the arrangement of the reactor in the form of a stack of layers makes the latter barely compact.

The present invention aims to provide a fixed-bed tubular reactor enabling a more uniform distribution of the reagents within the solid catalyst.

The present invention also aims to provide a fixed-bed tubular reactor enabling a more homogeneous distribution of the heat flow generated within the solid catalyst.

The present invention also aims to provide a tubular reactor enabling better cooling management.

The present invention also aims to provide a tubular reactor for which the reliability and the service life are improved compared to the reactors known from the prior art.

The present invention also aims to provide a tubular reactor allowing optimising (increasing) the passage time of the gases in the fixed catalytic powder bed.

### DISCLOSURE OF THE INVENTION

The aims of the present invention are achieved, at least in part, by a fixed-bed tubular reactor which extends, according to a longitudinal axis XX', between a first end and a second end, said reactor comprises a catalytic powder bed confined in an annular space delimited by an inner wall, called first wall, of a hollow tube and an outer wall, called second wall, of a hollow insert disposed coaxially in the hollow tube,
the hollow insert comprises at least one distribution chamber and at least one collection chamber, separated from each other by at least one partition wall, and comprising, respectively, a gas intake opening at the first end and a gas discharge opening at the second end,
the at least one distribution chamber is provided with a plurality of distributing openings whereas the at least one collection chamber is provided with a collecting opening, the plurality of distributing openings and the collecting opening of each collection chamber are formed at the second wall and extend parallel to the longitudinal axis XX', the distributing openings of a distribution chamber enabling the distribution of a gas capable of being admitted through the intake opening from said distribution chamber towards the annular space and the collecting opening enabling the collection of the gas distributed in the annular space by the collection chamber.

Each distributing opening and/or each collecting opening may be formed by one single opening,

Alternatively, a distributing opening and/or a collecting opening may comprise a plurality of openings, for example aligned according to its direction of extension.

According to one implementation, each distributing opening of the plurality of distributing openings of the at least one distribution chamber is shaped so as to impose a pressure drop on the gas likely to be admitted into the distribution chamber so that the flow rate of said gas depends on the path, called reactive path, of said gas in the annular space between the considered distributing opening and the collecting opening.

According to one implementation, the pressure drop increases when the reactive path decreases.

According to one implementation, the pressure drop increases when the reactive path increases.

According to one implementation, the pressure drop associated with a given distributing opening is adjusted by its section and/or its length.

According to one implementation, a porous element is accommodated within the distributing opening, the porous element having a porosity allowing imposing the pressure drop.

According to one implementation, the porous element may comprise at least one of the materials selected from among: a fibrous material, in particular wool, a braid or a metal or ceramic fabric.

According to one implementation, said reactor is provided with a porous film covering the second wall, and arranged so as to prevent the passage of powder from the catalytic powder bed through the distributing openings or the collecting opening.

According to one implementation, the at least one distribution chamber is sealed at the second end, and the at least one collection chamber is sealed at the first end.

According to one implementation, said reactor comprises, at the first end and at the second end, respectively, a distributing space and a collecting space between which the insert is disposed.

According to one implementation, the catalytic powder is retained in the annular space by a seal made of fibrous material at each of the ends of the annular space, advantageously, the seal made of fibrous material is held in compression against the catalytic powder by a spring, the spring abutting against a mechanically-linked holding plate of the tube.

According to one implementation, the second wall has no opening on a first section and a second section which extend from, respectively, the first end and the second end, the first section and the second section overlapping with the powder bed over a height H1, the height H1 being comprised between 0.2 times and 10 times, advantageously comprised between 1 times and 2 times, the distance D₁ separating a distributing opening from an immediately adjacent collecting opening, and measured along the outer surface of the outer wall.

According to one implementation, the hollow insert is provided with centring means holding the latter in a position coaxial with the hollow tube, advantageously, the centring means comprise bosses formed on the second wall.

According to one implementation, the collecting opening and the distributing openings have a width comprised between 1/100 and ½, advantageously comprised between 1/20 and ¼, of the diameter of the hollow tube.

According to one implementation, the hollow insert forms a single-piece part.

### BRIEF DESCRIPTION OF THE DRAWINGS

Other features and advantages will become apparent in the following description of the fixed-bed tubular reactor according to the invention, given as non-limiting examples, with reference to the appended drawings wherein:

FIG. 1 is a schematic representation of a fixed-bed tubular reactor according to the present invention, in particular, FIG. 1 represents the reactor according to a longitudinal sectional plane passing through a longitudinal axis XX' of said reactor;

FIG. 2 is a sectional view according to a transverse plane, perpendicular to the longitudinal axis XX' of the tubular reactor of FIG. 1, according to this representation, the tubular reactor comprises two distribution chambers and two collection chambers, the arrows symbolise the direction of circulation of the gas(es) in the annular space;

FIG. 3 is a schematic representation of an insert according to the present invention, in particular, the broken line represents a partition wall separating a distribution chamber and a collection chamber;

FIG. 4 is a sectional view according to a transverse plane, perpendicular to the longitudinal axis XX' of the tubular reactor according to a first variant of the present invention;

FIG. 5 is a sectional view according to a transverse plane, perpendicular to the longitudinal axis XX' of the tubular reactor according to a second variant of the present invention;

FIG. 6 is a representation of a porous element, and in particular of a porous element formed by 4 fibre planes, capable of being implemented in the tubular reactor according to the present invention;

FIG. 7 is a schematic representation of a fixed-bed tubular reactor according to another example of the present invention, in particular, FIG. 7 represents the reactor according to a longitudinal sectional plane passing through a longitudinal axis XX' of said reactor.

FIG. 8 is a schematic representation of a fixed-bed tubular reactor according to another example of the present invention, in particular, FIG. 8 represents the reactor according to a longitudinal sectional plane passing through a longitudinal axis XX' of said reactor.

### DETAILED DISCLOSURE OF PARTICULAR EMBODIMENTS

The present invention relates to a tubular reactor-exchanger with a fixed catalytic powder bed. In particular, the catalytic powder bed is confined in an annular space delimited by a first wall of a hollow tube and a second wall of a hollow insert accommodated coaxially in said tube.

In particular, the hollow insert according to the present invention is arranged so as to enable admission of reactive gases according to a first end of the reactor into a distribution chamber of said insert.

Afterwards, these are distributed in the annular space by a plurality of distributing openings enabling passage of said gases from the distribution chamber towards said annular space.

Afterwards, the products resulting from the reaction between reactive species are collected, via a collecting opening, in a collection chamber of the hollow insert, isolated from the distribution chamber by a partition wall.

The discharge of the products is done through a discharge opening of the collection chamber at the second end.

The implementation of a plurality of distributing openings allows splitting the distribution of reactive gas, from the same distribution chamber, at different locations of the catalytic powder bed. Thus, this mode of distribution limits the apparition of hot spots and preserves the performances of the catalytic powder bed.

Moreover, the consideration of a plurality of distributing openings allows limiting the number of distribution and collection chambers and consequently simplifying the architecture of the tubular reactor-exchanger with a fixed catalytic powder bed.

According to another aspect of the present invention, each distributing opening of the plurality of distributing openings of the distribution chamber is shaped so as to impose a pressure drop on the gas capable of being admitted into the distribution chamber so that the flow rate of the latter depends on the path, called reactive path, of said gas in the annular space between the considered distributing opening and the collecting opening. In particular, this pressure drop can increase when the reactive path decreases. Conversely, the pressure drop may increase when the reactive path increases.

The advantages associated with the different aspects of the present invention will appear more clearly upon reading the following detailed description.

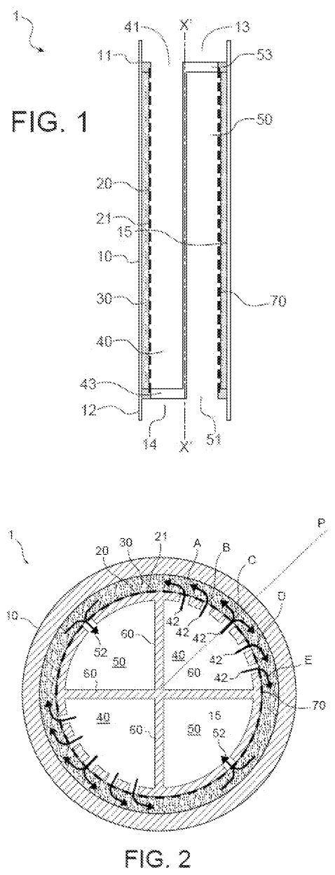

Thus, in FIGS. 1 and 2, an embodiment of a fixed-bed tubular reactor according to the present invention is shown.

The tubular reactor 1 according to the present invention comprises a hollow tube 10 which extends according to a longitudinal axis XX', between a first end 11 and a second end 12. It should be understood that the longitudinal axis XX' is also an axis of revolution of the hollow tube.

The hollow tube 10 may have an axisymmetry around the longitudinal axis XX'.

The hollow tube 10 may comprise a metal, and in particular a metal selected from among: steel, aluminium, copper, nickel alloy.

The diameter of the inner surface, called first surface, of the hollow tube may be comprised between 5 mm and 100 mm.

The wall, called first wall 15, forming the hollow tube 10 may have a thickness comprised between 0.5 mm and 10 mm.

The hollow tube 10 may have a length comprised between 10 times and 200 times the diameter of the first surface.

The tubular reactor 1 also comprises a hollow insert 20 which also extends according to the longitudinal axis XX' and has a generally cylindrical shape.

In particular, the hollow insert 20 is accommodated in the volume V of the hollow tube coaxially with the latter. In particular, the insert 20 also comprises a wall, called the second wall 21, which delimits with the first wall 15 an annular space 30.

In this respect, the annular space 30 is filled with a catalytic powder which will be the site of the reactions of conversion of reactive gases likely to transit through the tubular reactor 1.

The annular space 30 may have a thickness, defined as the distance between the first wall 15 and the second wall 21, comprised between 2% and 20% of the diameter of the first surface.

The hollow insert 20 may be a single-piece part.

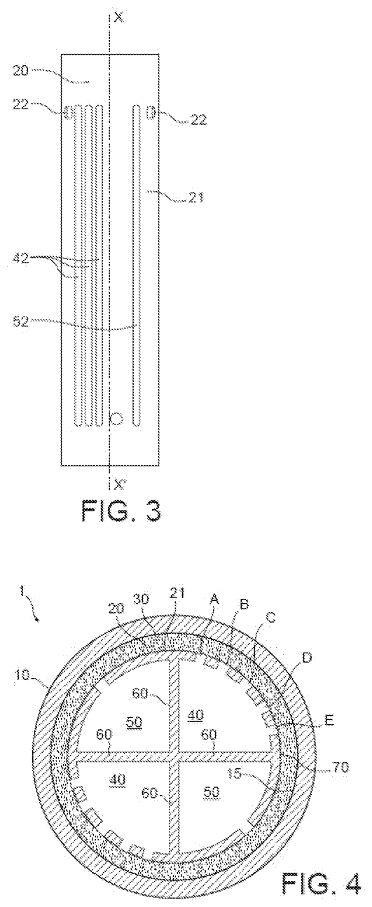

In a particularly advantageous manner, the hollow insert 20 may be provided with centring means holding the latter in a position coaxial with the hollow tube. For example, as represented in FIG. 3 the centring means comprise bosses 22 formed over the second wall.

In particular, these centring means allow considering a hollow insert with a length at least 20 times larger than the diameter of said insert.

Moreover, these means also allow facilitating mounting of the tubular reactor 1.

Moreover, the hollow insert 20 comprises at least one distribution chamber 40 and at least one collection chamber 50. In particular, the hollow insert 20 may comprise between 1 and 4 distribution chambers 40 and between 1 and 4 collection chambers 50.

Advantageously, the distribution chambers 40 and the collection chambers 50 are disposed alternately, and extend over the entire length of the hollow insert 20. Moreover, the collection 50 and distribution 40 chambers are separated from each other by partition walls 60.

For example, the partition walls 60 form planes passing through the longitudinal axis XX'.

Hence, it should be understood that a distribution chamber 40 is delimited by two partition walls 60 and a section of the second wall 21.

Equivalently, a collection chamber 50 is also delimited by two partition walls 60 and another section of the second wall 21.

Moreover, the partition walls 60 extend over the entire length of the hollow insert in the volume defined by the hollow insert 20, and are arranged so as to prevent any direct passage of gas from one chamber to another.

Furthermore, the at least one distribution chamber 40 comprises an intake opening 41 at the first end 11 of said insert 20 through which one or more reactive gas(es) can be admitted.

Equivalently, the at least one collection chamber 50 comprises a discharge opening 51 at the second end 12 of the hollow insert 20 and through which one or more gas(es) can be discharged.

The hollow insert 20 is also provided with a plurality of distributing openings 42 and at least one collecting opening 52.

In particular, each distribution chamber 40 comprises a plurality of distributing openings 42 (FIGS. 2 and 3) formed at the second wall 21, and which extend parallel to the longitudinal axis XX'. In particular, the plurality of distributing openings 42 of a given distribution chamber 40 is formed so as to make the considered distribution chamber 40 and the annular space 30 communicate with one another. In other words, the plurality of distributing openings 42 form as many passages permeable to reactive gases from the distribution chamber 40 towards the annular space 30.

Each distributing opening may be formed by one single opening,

Alternatively, a distributing opening may comprise a plurality of openings, for example aligned according to its direction of extension.

Equivalently, each collection chamber 50 comprises a collecting opening 52 (FIGS. 2 and 3) formed at the second wall 21, and which extends parallel to the longitudinal axis XX'. In particular, the collecting opening 52 of a given collection chamber 50 is formed so as to make the considered collection chamber 50 and the annular space communicate with one another. In other words, the collecting opening 52 forms a gas-permeable passage from the annular space 30 towards the collection chamber 50.

Each collecting opening may be formed by one single opening,

Alternatively, a collecting opening may comprise a plurality of openings, for example aligned according to its direction of extension.

Thus, the distributing openings 42 of a distribution chamber 40 enable the distribution of a gas capable of being admitted through the intake opening 41 from said distribution chamber towards the annular space 30, whereas the collecting opening 52 enables the collection of the gas distributed in the annular space 30 by the collection chamber.

More particularly, the multiplicity of the distributing openings 42 associated with a given distribution chamber thus allows injecting a reactive gas into the annular space 30 at different areas (areas A, B, C, D, and E in FIG. 2) of said space 30. This distribution of the gas injection areas allows replicating the principle of staged injection and thus limiting the apparition of local heat-up (hot spots) at the annular area 30. This limitation of heat-up also prevents any phenomenon of sintering of the catalytic powder present in the annular space.

Considering a plurality of distributing openings 42 per distribution chamber 40 allows considering a hollow insert 20 limited to one single, and possibly two, distribution chamber(s). Moreover, such an arrangement allows simplifying the manufacture of the hollow insert 20.

Advantageously, the distributing 42 and collecting 52 openings extend over a length L, and parallel to the longitudinal axis XX'.

Advantageously, the length L is larger than half, advantageously three quarters of the length of extension according to the longitudinal axis XX' of the annular space 30.

The extension of the distributing openings 42 over the length L also allows spreading out the injection of gas into the annular space 30 and thus limiting the apparition of hot spots.

Advantageously, the distributing openings 42 of a given distribution chamber 40 may be arranged symmetrically with respect to a bisector plane P of the walls 60 delimiting said chamber (FIG. 2).

More particularly, each distribution chamber may comprise an odd number of distributing openings 42. According to this arrangement, one of the distributing openings 42, called central opening, is disposed at the intersection of the bisector plane and the second wall 21, whereas the other openings of the plurality of openings 42 are disposed symmetrically on either side of said bisector plane.

For example, and as illustrated in FIG. 2, each distribution chamber 42 comprises five distributing openings 42.

Advantageously, the tubular reactor 1 comprises a filter arranged so as to prevent the passage of the catalytic powder into the distribution 40 or collection 50 chambers.

For example, as illustrated in FIG. 3, a filter 70 may be disposed overlapping the second wall 21.

In a particularly advantageous manner, each distributing opening 42 of the plurality of distributing openings of a distribution chamber 40 is shaped so as to impose a pressure drop on the gas capable of being admitted into said distribution chamber 40 which depends on the path, called reactive path, of said gas in the annular space 30 between the considered distributing opening 42 and the collecting opening 52.

In particular, the pressure drop may increase when the reactive path decreases. Thus, referring to FIG. 2, the pressure drop imposed by the distributing openings 42 at the positions A and E may be higher than the pressure drop imposed by the opening at the position C. In turn, the openings 42 at the positions B and D may impose an intermediate pressure drop between that imposed at the positions A and E on the one hand and the position C on the other hand.

Thus, the adjustment of the pressure drops according to the reactive path allows better controlling the gas flow rates during distribution thereof in the annular space.

According to a first variant illustrated in FIG. 4, the pressure drop associated with a given distributing opening is adjusted by its section and/or its length L. More particularly, the pressure drop of an opening increases as its section and/or its length L decreases.

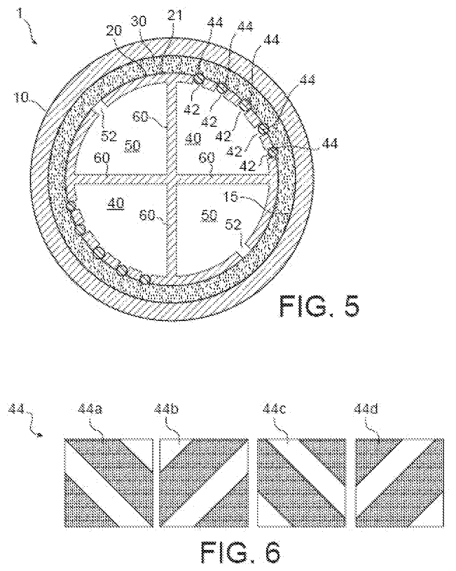

According to a second variant illustrated in FIG. 5, porous elements 44 are accommodated in each of the distributing openings. In particular, each porous element 44 has a porosity allowing imposing a predetermined pressure drop. In this respect, the porous element may comprise at least one of the materials selected from among: a fibrous material, in particular wool, a braid or a metallic or ceramic fabric. Alternatively, the porous element associated with a given distributing opening may be formed directly with the hollow insert.

According to this last configuration, and as illustrated in FIG. 6, the porous element 44 may comprise a plurality of planes 44a, 44b, 44c and 44d comprising fibres. The example illustrated in FIG. 6 comprises in particular 4 planes, each provided with rectangular or round fibres and inclined at +/−45° with respect to the longitudinal axis XX'. More particularly, the fibres of two successive planes are oriented according to two different angles, and are in particular perpendicular from one plane to another.

According to a third variant, the filter 70 may have variations in thickness and/or porosity at the distributing openings.

Advantageously, the at least one distribution chamber 40 is sealed at the second end 12, whereas the at least one collection chamber 50 is sealed at the first end 11. In this respect, as illustrated in FIG. 1, the distribution chamber 40 is sealed by a distribution wall 43, whereas the collection chamber 50 is sealed by a collection wall 53.

Complementarily, the tubular reactor 1 may comprise at the first end 11 and at the second end 12, respectively, a distributing space 13 and a collecting space 14 between which the hollow insert 20 is disposed.

Advantageously, the collecting opening 52 and the distributing openings 42 have a width comprised between 1/100 and ½, advantageously comprised between 1/20 and ¼, of the diameter of the hollow tube 10.

Thus, during operation of the reactor, one or more reactive gases are admitted into the distribution chamber 40 through the intake opening 41. Afterwards, these gases pass throughout the distributing openings 42 associated with said distribution chamber, and flow into the annular space 30 in order to be brought into contact with the catalytic powder bed. During this flow in the annular space, the reactive gases are converted, at least in part, into products. These, as well as the fraction of reactive gases that have not reacted, pass throughout the collecting opening thus considered and are collected in the collection chamber. Afterwards, the products and unreacted reactive gases thus collected are discharged through the discharge opening 51.

Thus, the extent of the distributing openings over the length L allows distributing the reactive gases in the annular space over said length L. In other words, this arrangement allows distributing the amount of heat likely to be produced during the conversion of the reactive gases into products over the entire length L. Thus, this arrangement allows limiting the increase in local temperature of the catalytic powder bed. According to an equivalent principle, the extension over the length L of the collecting openings allows limiting the heat-up of the catalytic powder bed.

Moreover, the arrangement of the intake 41 and discharge 51 openings on opposite ends of the hollow insert also contributes to a better distribution of the reagents within the annular space 30 and consequently to a better homogenisation of the temperature of the catalytic powder bed.

All these aspects contribute in limiting the apparition of hot spots and thus preserving the catalytic powder bed. This results in a better reliability of the tubular reactor and an increase in its service life.

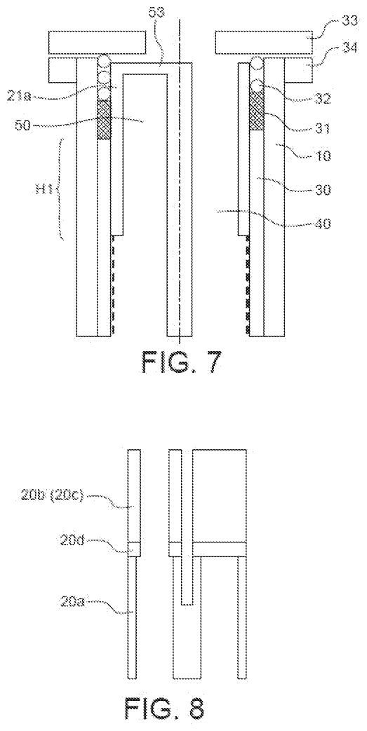

According to a particularly advantageous aspect illustrated in FIG. 7, the catalytic powder is retained in the annular space 30 by a seal 31 made of fibrous material at each of the ends of said annular space 30.

To the extent that the seal is made of fibrous material, the latter is necessarily porous and therefore permeable to reactive gases.

In this respect, the fibrous material may comprise at least one of the elements selected from among: fibreglass, ceramic fibre, metal fibre, carbon fibre, polymer material fibre.

In particular, the seal 31 may be in the form of a braid, a sheath, a cord or simply comprise a stuffing of the fibrous material.

Advantageously, the fibrous material is a thermal insulator and has a thermal conductivity substantially equivalent to that of the used catalyst (0.2 W/m/K to 10 W/m/K).

According to an advantageous embodiment, the seal 31 made of fibrous material is held in compression against the catalytic powder by a spring 32. For example, the spring 32 abuts against a retaining plate 33 mechanically linked to the tube by a ring 34.

The seal 31 made of fibrous material in combination with the spring(s) allows better compacting the catalytic powder and preventing the attrition of the latter during handling or transport of the reactor.

To the extent that the seal 31 is porous, the reactive gases can enter the annular space directly without passing through the distribution chamber 40.

In this case (FIG. 7), it is particularly advantageous to provide for an arrangement of the hollow insert 20 allowing imposing on this reactive gas a predetermined pathway in the annular space in order to promote conversion thereof in contact with the catalytic powder bed. This predetermined path has a length comprised between 0.2 times and 10 times, advantageously between 1 time and 2 times, the reactive path defined with reference to the figure.

To this end, the second wall 21 may be devoid of openings over a first section 21a and a second section which extend starting from the first end 11 and the second end 12, respectively.

In this respect, the first section 21a and the second section overlap with the powder bed over a height H1. The height H1 being comprised between 0.5 times and 10 times, advantageously between one time and 2 times, the reactive path.

FIG. 8 represents a hollow insert 20 capable of being implemented according to another example of the present invention. This other example essentially replicates the features set out before.

The insert 20 relating to this other example may be manufactured by machining, by cutting, by electrical-discharge machining, by extrusion.

In particular, the insert 20 comprises, according to this other example, a main body 20a interposed between two end bodies 20b, and assembled by means of a seal 20d.

The two terminal bodies 20b, illustrated in FIG. 8, comprise a cylindrical wall not permeable to gas replicating the previously-described first section 21a, and comprises distributing 41 (or collecting 51) openings.

Advantageously, the tubular reactor according to the present invention is implemented for the synthesis of methane, methanol, dimethyl ether or to implement the Fisher-Tropsch synthesis.

What is claimed is:

1. A fixed-bed tubular reactor which extends, according to a longitudinal axis, between a first end and a second end, said reactor comprises a catalytic powder bed confined in an annular space delimited by an inner wall, called first wall, of a hollow tube and an outer wall, called second wall, of a hollow insert disposed coaxially in the hollow tube,
the hollow insert comprises at least one distribution chamber and at least one collection chamber, separated from each other by at least one partition wall, and comprising, respectively, a gas intake opening at the first end and a gas discharge opening at the second end,
the at least one distribution chamber is provided with a plurality of distributing openings whereas the at least one collection chamber is provided with a collecting opening, the plurality of distributing openings and the collecting opening of each collection chamber are formed at the second wall and extend parallel to the longitudinal axis, the distributing openings of a distribution chamber enabling the distribution of a gas capable of being admitted through the intake opening from said distribution chamber towards the annular space and the collecting opening enabling the collection of the gas distributed in the annular space by the collection chamber.

2. The reactor according to claim 1, wherein each distributing opening of the plurality of distributing openings of the at least one distribution chamber is shaped so as to impose a pressure drop on the gas likely to be admitted into the distribution chamber so that the flow rate of said gas depends on the path, called reactive path, of said gas in the annular space between the considered distributing opening and the collecting opening.

3. The reactor according to claim 2, wherein the pressure drop increases when the reactive path decreases.

4. The reactor according to claim 3, wherein the pressure drop associated with a given distributing opening is adjusted by its section and/or its length.

5. The reactor according to claim 3, wherein a porous element is accommodated within the distributing opening, the porous element having a porosity allowing imposing the pressure drop.

6. The reactor according to claim 5, wherein the porous element may comprise at least materials selected from among: a fibrous material, in particular wool, a braid or a metal or ceramic fabric.

7. The reactor according to claim 3, wherein said reactor is provided with a porous film covering the second wall, and arranged so as to prevent the passage of powder from the catalytic powder bed through the distributing openings or the collecting opening.

8. The reactor according to claim 1, wherein the at least one distribution chamber is sealed at the second end, and the at least one collection chamber is sealed at the first end.

9. The reactor according to claim 1, wherein said reactor comprises, at the first end and at the second end, respectively, a distributing space and a collecting space between which the insert is disposed.

10. The reactor according to claim 1, wherein the catalytic powder is retained in the annular space by a seal made of fibrous material at each of the ends of the annular space, the seal made of fibrous material is held in compression against the catalytic powder by a spring, the spring abutting against a mechanically-linked holding plate of the tube.

11. The reactor according to claim 1, wherein the second wall has no opening on a first section and a second section which extend from, respectively, the first end and the second end, the first section and the second section overlapping with the powder bed over a height, the height being comprised between 0.2 times and 10 times the distance separating a distributing opening from an immediately adjacent collecting opening, and measured along the outer surface of the outer wall.

12. The reactor according to claim 1, wherein the hollow insert is provided with centring means holding the latter in a position coaxial with the hollow tube, advantageously, the centring means comprise bosses formed on the second wall.

13. The reactor according to claim 1, wherein the collecting opening and the distributing openings have a width comprised between 1/100 and ½of the diameter of the hollow tube.

14. The reactor according to claim 1, wherein the hollow insert forms a single-piece part.
